(19) United States
(12) Patent Application Publication
(10) Pub. No.: US 2003/0166400 A1
(43) Pub. Date: Sep. 4, 2003

(54) Method and apparatus for electronic data sharing

(76) Inventor: Stephen Lucas, Hopewell, NY (US)

Correspondence Address: THOMPSON & KNIGHT L.L.P., PATENT PROSECUTION DEPARTMENT, 98 SAN JACINTO BLVD., SUITE 1200, AUSTIN, TX, 78701, US

(21) Appl. No.: 10/217,961

(22) Filed: Aug. 13, 2002

Related U.S. Application Data
(60) Provisional application No. 60/311,903, filed on Aug. 13, 2001.

(51) Int. Cl. H04M 3/42

(52) U.S. Cl. 455/425; 455/414

(57) ABSTRACT

Data devices that receive data, store the data, and transmit the data without performing heavy computation. For example, such a data device may have a memory component and communication mechanism that transmits data and receives data. In the preferred embodiment, the data transmission would be wireless. Among other applications, one application of the data device would be to wireless payment systems.

Some applications of the data device authenticate a user's identity via biometric technology requiring a low level of computing resources.

### CROSS-REFERENCE TO RELATED APPLICATIONS

This application claims the benefit of the following U.S. Provisional Application, which is hereby incorporated by reference, and the content of which is not necessarily identical to the content of this application:

COMMONLY OWNED AND PREVIOUSLY FILED
U.S. PROVISIONAL PATENT APPLICATIONS

| Atty. Dkt. # | Serial Number | Title | Filing Date |
|---|---|---|---|
| Not available | 60/311,903 | Method and Apparatus for | Aug. 13, |
| | | Electronic Data Sharing | 2001 |

The benefit of 35 U.S.C. § 120 is claimed for the above referenced commonly owned application.

All references cited hereafter are incorporated by reference to the maximum extent allowable by law. To the extent a reference may not be fully incorporated herein, it is incorporated by reference for background purposes and indicative of the knowledge of one of ordinary skill in the art.

### BACKGROUND OF THE INVENTION

1. Field of the Invention

The present invention relates to the field of electronic data sharing.

2. Description of Related Art

Personal digital assistants (PDAs) have been developed as handheld computers to store, access, organize, and manipulate information. They may operate using a Windows® based or Palm® operating system. PDAs can allow data manipulation by screen input, keyboard input or both. Most PDAs allow storage, retrieval, and manipulation of addresses, phone numbers, calendars, to-do lists, etc. Some PDAs allow e-mail and Internet access via wireless, telephone jack, or other means. PDAs can typically connect to a personal computer whether desktop or notebook. PDAs come in a variety of sizes and some incorporate the functionality of mobile telephones. The many PDA innovations have solved many problems, but other problems have been left unsolved.

Real-world application of electronic data sharing technology typically requires, or at least benefits from, the use of identity authentication technology. Biometric authentication of identity has seen rapid development, and has great potential. But biometric authentication of identity has required the application of substantial computing power.

### BRIEF SUMMARY OF THE INVENTION

Embodiments of the present invention relate generally to data devices that receive data, store the data, and transmit the data without performing heavy computation. For example, such a data device may have a memory component and communication mechanism that transmits data and receives data. In the preferred embodiment, the data transmission would be wireless. Among other applications, one application of the data device would be to wireless payment systems.

Furthermore, many embodiments of the present invention authenticate a user's identity via biometric technology requiring a low level of computing resources.

### BRIEF DESCRIPTION OF THE DRAWINGS

The following drawings form part of the present specification and are included to further demonstrate certain aspects of the present invention. The figures are not necessarily drawn to scale. The invention may be better understood by reference to one or more of these drawings in combination with the detailed description of specific embodiments presented herein.

FIG. 1 shows a data device in accordance with an embodiment of the present invention.

FIG. 2 shows a data sharing process flow in accordance with an embodiment of the present invention.

FIG. 3 shows a payment transaction process flow in accordance with an embodiment of the present invention.

FIG. 4 shows a payment transaction flow that includes biometric authentication in accordance with an embodiment of the present invention.

FIG. 5 shows a payment transaction process flow across the Internet in accordance with an embodiment of the present invention.

FIG. 6 shows a data device function key diagram in accordance with an embodiment of the present invention.

FIG. 7 shows a data device function key diagram in accordance with an embodiment of the present invention.

FIG. 8 shows a data device function key diagram in accordance with an embodiment of the present invention.

FIG. 9 shows several data device designs in accordance with an embodiment of the present invention.

FIG. 10 shows several data device designs in accordance with an embodiment of the present invention.

FIG. 11 shows several data device designs in accordance with an embodiment of the present invention.

FIG. 12 shows several data device designs in accordance with an embodiment of the present invention.

FIG. 13 shows a data device with a clip in accordance with an embodiment of the present invention.

FIG. 14 shows a data device with a docking station in accordance with an embodiment of the present invention.

FIG. 15 shows a data device badge in accordance with an embodiment of the present invention.

FIG. 16 shows a data device necklace in accordance with an embodiment of the present invention.

FIG. 17 shows a data device bracelet in accordance with an embodiment of the present invention.

FIG. 18 shows a data device contact card case in accordance with an embodiment of the present invention.

FIG. 19 shows a data device digital imager in accordance with an embodiment of the present invention.

FIG. 20 shows a data device pen in accordance with an embodiment of the present invention.

FIG. 21 shows a data device pen cap in accordance with an embodiment of the present invention.

FIG. 22 shows a data device mobile phone module in accordance with an embodiment of the present invention.

FIG. 23 shows a data device PDA module in accordance with an embodiment of the present invention.

FIG. 24 shows a data device PDA wand in accordance with an embodiment of the present invention.

FIG. 25 shows another data device in accordance with an embodiment of the present invention.

FIG. 26 shows another data device in accordance with an embodiment of the present invention.

### DETAILED DESCRIPTION OF PREFERRED EMBODIMENTS

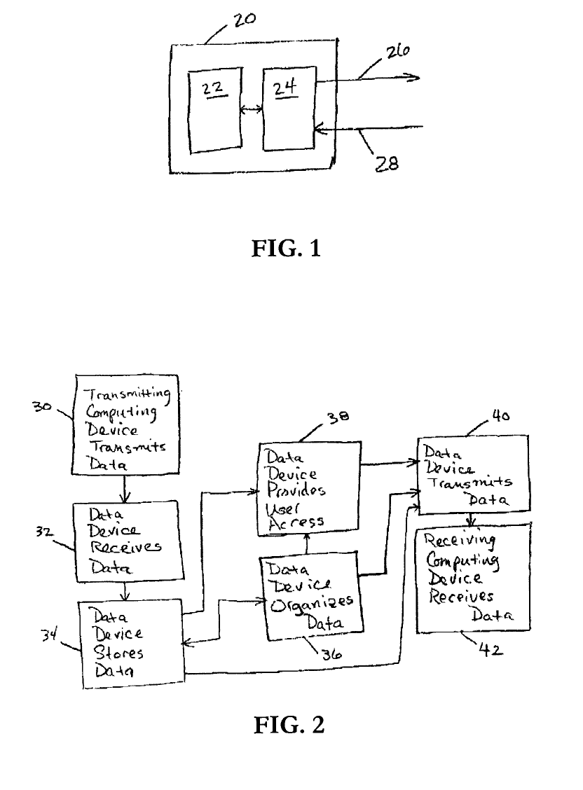

Turning to FIG. 1 a data device 20 includes a memory 22 and a communication mechanism 24. Communication mechanism 24 is enabled to transmit data 26 and receive data 28. In the preferred embodiment the data would be transmitted wirelessly and received wirelessly, but many embodiments implement the communication mechanism as a hardwire connection, for example, a USB connection. In addition, the data device 20 of the preferred embodiment would perform no more computation than organization of the stored data. In some embodiments, the user may be allowed to access the stored data and that access may be visual. The wireless communications technology might be infrared transmission, Bluetooth™ or other wireless technology. In addition, some embodiments of the data device would not be capable of organizing the stored data. In some system embodiments the data device would be capable of operating in a system including the data device, a first computing device, and a second computing device where the first computing device would transmit data to be received 28 by the data device 20 and the second computing device would receive data transmitted 26 by the data device 20.

In the preferred embodiment, the memory 22 is flash memory in sizes ranging from 1 megabit to 8 megabits, and 32K program memory resides on-chip. Many embodiments have other memory types, for example, removable sandisks, memory sticks, micro-hard drives, significantly larger flash memory chips, etc.

The communication mechanism of the preferred embodiment includes infrared technology. The IrDA specification called IrDA Lite is used. Payment-related transactions can be implemented using the IrDA specification called IrFM. Other wireless communication mechanisms are Bluetooth™, 802.11b Wi-Fi, RF, etc. Business card data is being stored and organized according to the vCard standard. An example of a hardwire communication mechanism implemented in some embodiments is a mini USB plug, configured to access a Philips USB chip on the data device, that allows the device to be plugged into and access a personal computer via its USB port.

As has been indicated, other embodiments implement the invention without the specific memory, communication mechanism, etc. used in the preferred embodiment. Numerous and substantial differences exist between different embodiments of the present invention without causing departure from the scope of the present invention, as claimed.

Turning now to FIG. 2, an embodiment is shown for a process of data sharing. In step 30 a transmitting computing device transmits data. In step 32, the data device receives the data. In step 34, the data device stores the data. In step 36, the data device organizes the data. In step 38, the data device provides user access to the data. In step 40, the data device transmits the data and in step 42, a receiving computing device receives the data. After step 36 in which the data device organizes the data, the data device may then store the data in step 34 or the data device may provide user access to the organized data in step 38. If the data device does not organize the data after storing the data, then step 34 can be followed by step 38 without step 36 intervening. After the data device organizes the data in step 36 and/or after the data device provides user access to the data in step 38 or directly after the data device stores the data in step 34, then the data device can transmit the data in step 40. Note that when a user accesses the data device's data, the access may be to part or all of the data and that access may be visual or otherwise in nature. In the preferred embodiment, the transmission of the data and receipt of the data occurs wirelessly. Again, any wireless technology may be suitable including infrared, Bluetooth™, etc. And in some embodiments, the organization step will never be performed.

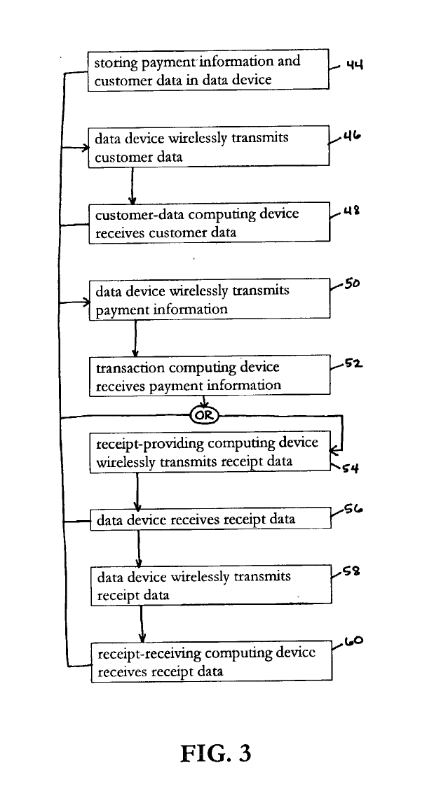

Turning now to FIG. 3, a process is disclosed for an embodiment of the present invention adapted to wireless payment transactions. First, in step 44, payment information and possibly customer data are stored in the data device. At that point, one of four possible processes occurs. The data device may wirelessly transmit the customer data to a customer data communicating device in steps 46 and 48. The data device may wirelessly transmit payment information to a transaction computing device in steps 50 and 52. In the preferred embodiment, receipt of the payment information by the transaction computing device enables a receipt providing computing device to wirelessly transmit receipt data to the data device in steps 54 and 56 at which point the data device may wirelessly transmit the receipt data to a receipt receiving computing device in steps 58 and 60. As in any robust transaction system, steps may be repeated, transmissions retransmitted, confirmations sent and received to verify the accuracy of transmissions, and other transactional protocols followed as appropriate. The payment information can be credit card information, stored cash value, coupon data, etc.

Many embodiments of the present invention enable implementation of “local” storage of biometric information for authentication, thereby achieving advantage over proposed and existing systems that require “centralized” storage of biometric information for authentication. Furthermore, such centralized systems require centralized storage of credit card or other payment information, and personal and demographic information. Thus, such centralized systems centrally store information that would be much more damaging if compromised together than would be the case if compromised singly-increasing the potential damage from identity cloning.

A typical Point of Sale (POS) transaction that includes user authentication proceeds according to the following flow:

1. The user identifies him/herself using identity authentication technology, for example, the SpeedPass™ RF tag, thumb on a biometrics reader, etc. at a POS terminal.

2. The identity authentication information is communicated from the POS terminal to a central database for a lookup.

3. If the lookup is successful, information is extracted from the database to complete the transaction, for example, credit card number, etc.

4. Credit card information is sent to a credit card payment processor for approval and a response of “approved” or “declined” is received.

5. The response is forwarded to the POS terminal.

That POS transaction flow has several disadvantages, including:

1. Users are typically reluctant to provide personal or financial information to the merchant or another party.

2. Further, users would be especially reluctant to provide biometric information, for example, a fingerprint, to another party for their retention.

3. Businesses relying on and supporting the flow fear that the information on the central server may be vulnerable to being compromised, and even if that is unlikely, the potential liability issues surrounding the potential of large-scale identity theft are feared. Cloned individuals cannot be issued “new” biometric information.

4. Information stored at the central server would be inconvenient to view or modify.

5. Each such flow depends on a existence of a central server, creating a closed system. Each new system, i.e., new server, requires users to enroll and undergo a setup process.

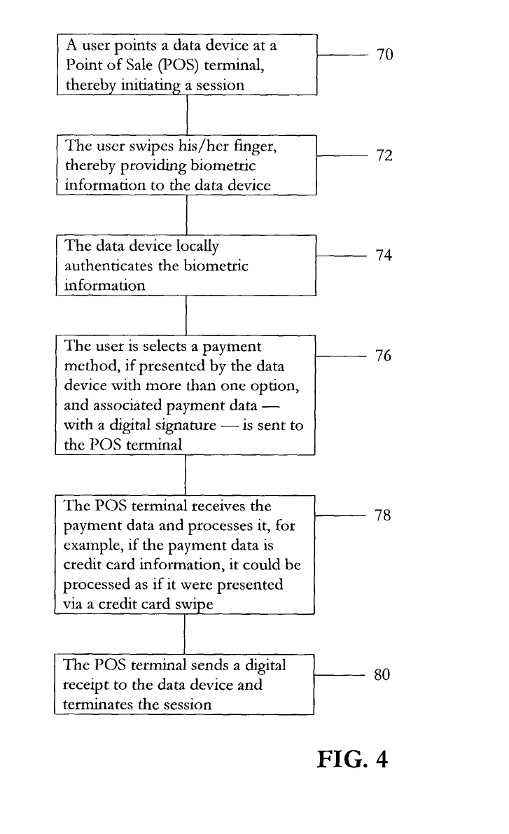

Many embodiments of the present invention are compatible with systems such as the above-discussed centralized systems. But, as stated above, many embodiments of the present invention enable implementation of “localized” systems. Some such localized systems could be called “point, swipe, and pay” systems. One example of a point, swipe, and pay system process flow is depicted in FIG. 4 and described by the following:

1. A user points a data device at a Point of Sale (POS) terminal, thereby initiating a session. (Step 70)

2. The user swipes his/her finger, thereby providing biometric information to the data device. (Step 72)

3. The data device locally authenticates the biometric information. (Step 74)

4. The user is selects a payment method, if presented by the data device with more than one option, and associated payment data—with a digital signature—is sent to the POS terminal. (Step 76)

5. The POS terminal receives the payment data and processes it, for example, if the payment data is credit card information, it could be processed as if it were presented via a credit card swipe. (Step 78)

6. The POS terminal sends a digital receipt to the data device and terminates the session. (Step 80)

The flow of this example of a localized system has several advantages over the above-presented flow of an example of a centralized system, some of which are:

1. Users maintain possession and full control of their biometric, payment, and other personal information.

2. Personal information is securely stored on the data device, only becoming accessible after a successful identity authentication step.

3. The localized system is an open system that allows merchants to participate by providing appropriately configured POS terminals without needing to establish their own centralized systems.

4. The localized system also eliminates the risk of a mass breach of personal information because the information is not centrally stored.

Many embodiments of the present invention are adapted to enable systems having process flows analogous to the above-discussed point, swipe, and pay flow, but being for systems in addition to or other than payment systems. Other than payment systems would include any setting in which personal information is required in connection with identity authentication. Such systems could be more easily established by taking advantage of an authentication authority. For example, an organization such as the United States Postal Service or the Department of Motor Vehicles of a state could act as an authentication agency, whereby a user would present a data device and proper personal identification. The authority would then enable the data device to be used as official identification for a wide range of applications.

FIG. 5 shows a payment transaction process flow analogous to that of FIG. 4, but rather than the user being physically present at a POS terminal, the transaction occurs with a vendor across the Internet. The example process proceeds as follows:

1. A user initiates a checkout session with an Internet merchant, thereby initiating a session. (Step 82)

2. The user swipes his/her finger, thereby providing biometric information to the data device. (Step 84)

3. The data device locally authenticates the biometric information. (Step 86)

4. The user selects a payment method, and associated payment data—with a digital signature—is sent to the user's personal computer and from there to the Internet merchant. (Step 88)

5. The Internet merchant receives the payment data and processes it, for example, if the payment data is credit card information, it could be processed as if it were typed in by the user. (Step 90)

6. The Internet merchant sends a digital receipt across the Internet to the data device and terminates the session. (Step 92)

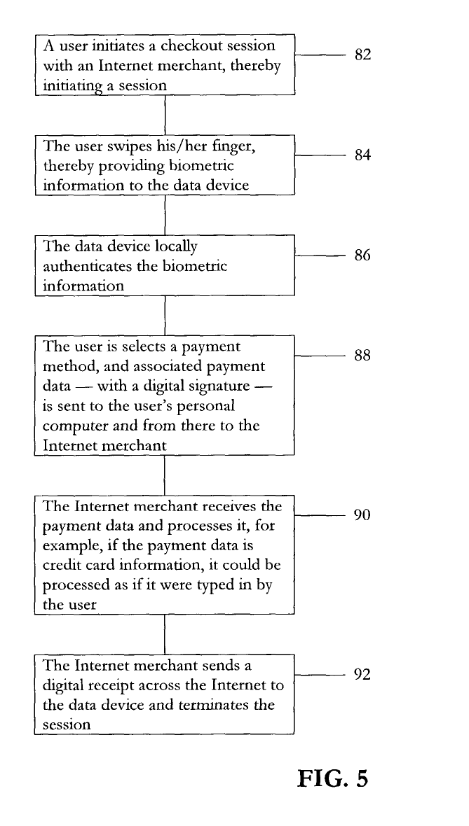

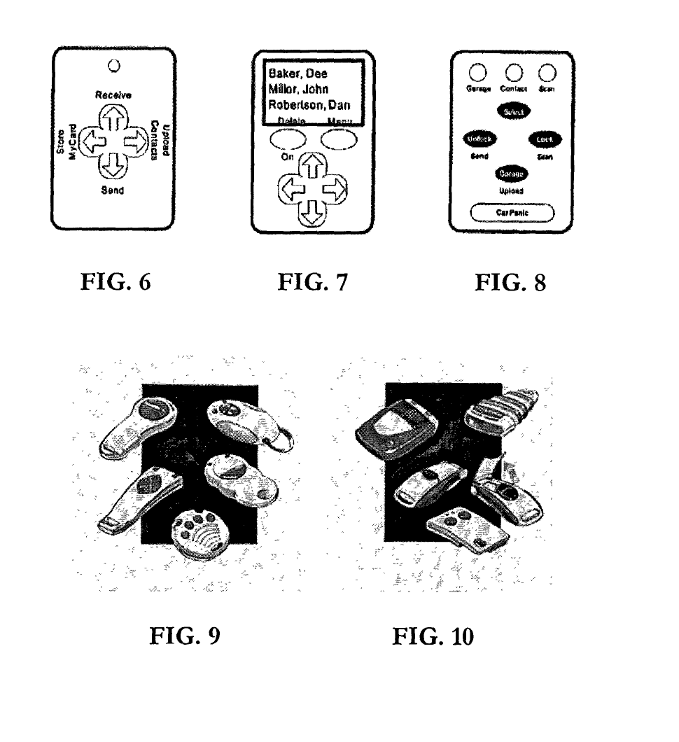

Various control panels and displays are possible in various embodiments of the present invention. Some examples are shown in FIGS. 6-8. For instance, transmission of data from a data device may be controlled by a button on the control panel of the data device. Similarly, enablement of the data device to receive data may be dependent upon actuation of a button on the data device's control panel. If the embodiment has a visual display that enables words to be displayed, then for example, if the memory contains a list of contact names, those names may be displayed on the data device's display and selection of which names appear may be dependent on actuation of selection buttons on the data device's control panel.

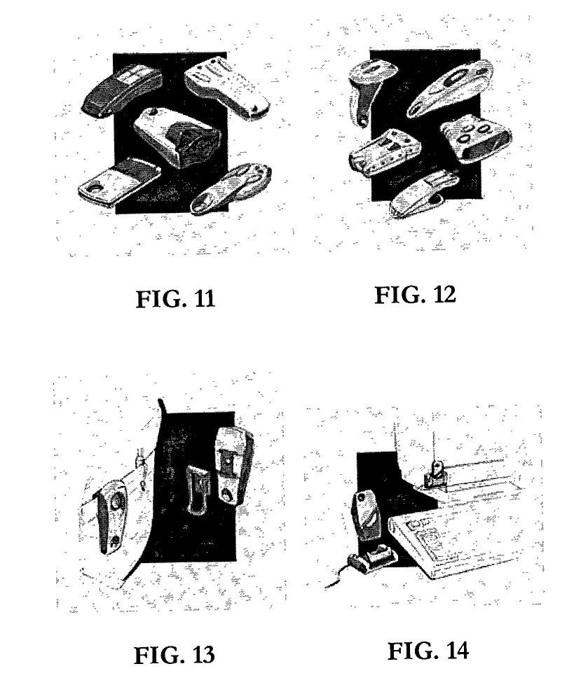

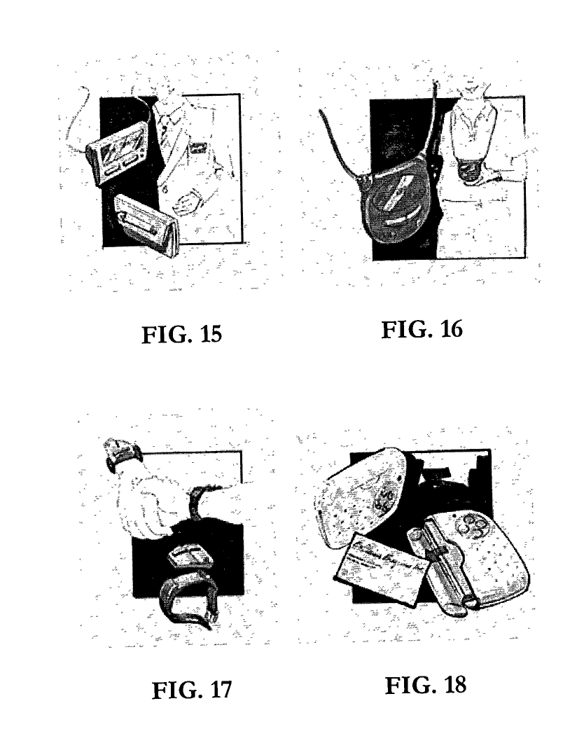

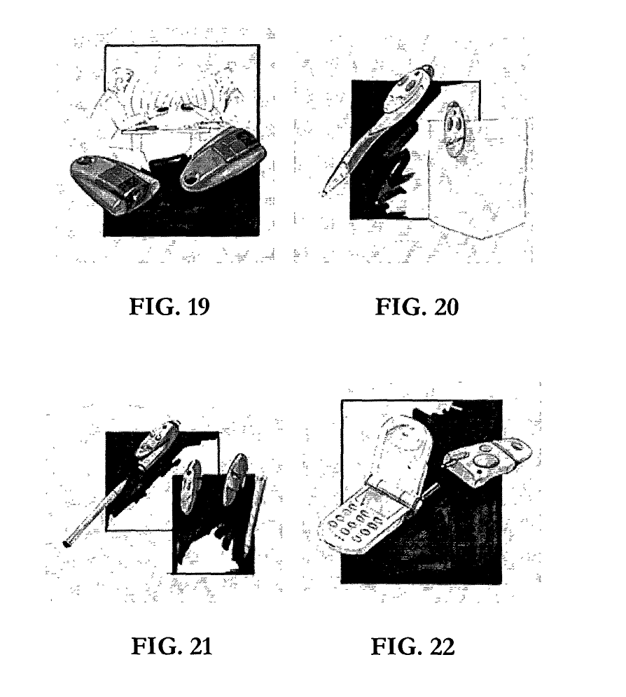

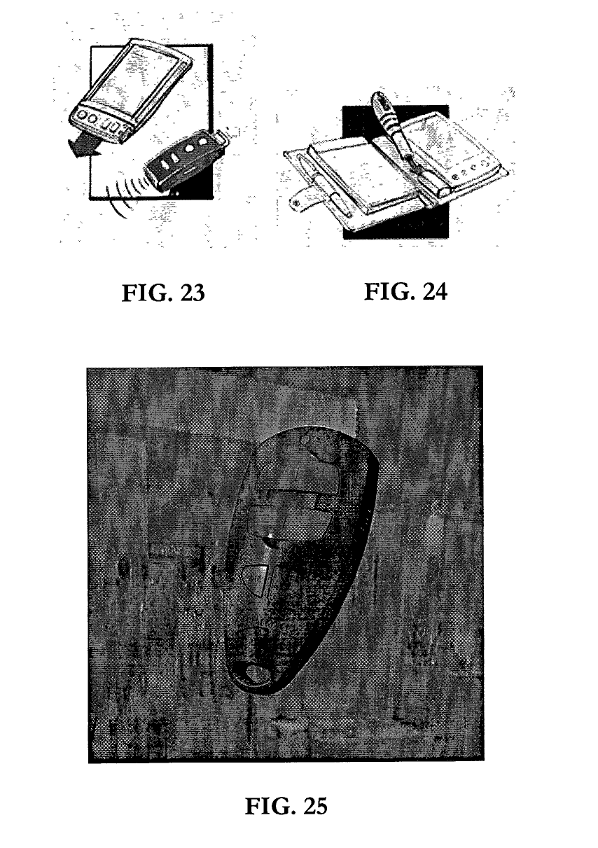

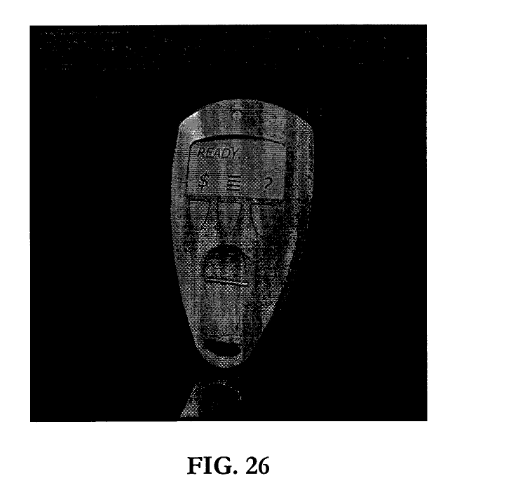

The physical form of the data device may take many shapes without departing from the scope of the claimed invention. Several examples are illustrated in FIGS. 9-26. For instance, the data device may be handheld device similar to a television remote control or a garage door opener. The device may be configured to enable clipping to a belt. A data device may be configured to plug-in to a personal computer docking station or worn as a badge, necklace, or bracelet. An embodiment of the data device of the present invention may be configured to contain business cards or to capture visual images. An embodiment may be in a pen shape coupled to a writing utensil or a pen cap detachably coupled to a writing utensil. An embodiment of the data device may be dockable to a cellular telephone or a PDA. Another embodiment of the present invention would be in the form of a PDA wand.

Many embodiments of the present invention authenticate the user's identity via biometric technology without requiring the high level of computing resources required by other technologies. In some embodiments, the reason that the computing power required is less is that the computing resources would be specifically designed for single-purpose application—e.g., fingerprint authentication.

One advantage of identity authentication is that merchants receiving credit card payment via an embodiment of the present invention may be able to obtain a “card present” rate from the credit card processing company rather than the typically higher “card not present” rate.

Another advantage of those embodiments of the present invention that implement applicable features, is achievement of “triple level authentication.” Triple Level Authentication occurs when a transaction has the benefit of authentication based on (1) something you have, for example a check, credit card, or handheld device, (2) something you know, for example a personal identification number, and (3) something you are, for example a signature or fingerprint.

It can be seen that embodiments of the present invention typically have a simple interface that allow the sharing or transport of information or control of the devices. Various embodiments allow users to organize, store, and exchange frequently used data. Examples of such data include business card information, credit card information, and loyalty and reward program information. Some embodiments may function as garage door openers, wireless automobile key entry systems, and barcode scanning technologies. Some embodiments can fit on a key-chain, or are handheld carried or worn devices that are easily transported. Embodiments of the present invention typically cost less than PDAs. The source of power for the devices is not important relative to the scope of the claimed invention. The preferred embodiment operates on battery power. Other possible data includes electronic check data, stored value data, electronic music files, and graphic images. Data may be received from another wireless device such as a PDA cell-phone, personal computer, credit card terminal, or laptop. Likewise, wireless data may be transferred to such devices. In addition, user authentication may be incorporated into embodiments of the present invention whether it be biometrics or other security measures. Such devices may have great capacity for reducing fraud.

Biometric authentication has been discussed primarily in terms of fingerprint information. But many embodiments of the invention utilize other authentication techniques based on biometric information, for example, voice recognition, etc.

For many applications, embodiments of the present invention may replace currently existing PDAs, wireless devices, wireless payment systems, keyless entry systems, loyalty and reward program cards, digital certificates, and corporate promotion items, for example. In addition, virtually any transaction that currently requires the exchange of paper in some form and manual interaction may be replicated without paper exchange via an embodiment of the present invention in communication with another computing device. Many embodiments of the present invention function as portable e-wallets that can connect to other devices via secure communications to enable financial or commercial transactions. For example, embodiments of the present invention functioning as e-wallets are not necessarily limited to transactions performed across the Internet from a personal computer.

In addition to infrared, Bluetooth™, and other discussed communication technologies, RFID is a possible communication technology, as is any other wireless communication technology. The communication protocol may be any that is understood by both the transmitting and receiving device. IrDA has been successful in establishing standards for the transfer of data using infrared protocols. For example, IrFM is a financial IR protocol. While other devices may perform some similar functions as an embodiment of the present invention, the devices are distinct from embodiments of the present invention. PDAs and cell-phones incorporate greater functionality than any embodiment of the present invention.

It should be noted that, as claimed, the functions of computing devices other than the data device may be partially or wholly combined in any manner without departing from the scope of the claimed invention. For example, in the embodiment that includes a transmitting computing device, a receiving computing device, and a data device, the transmitting computing device and the receiving computing device may be the same computing device.

Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provision of 35 U.S.C. § 112, ¶ 6.

It should be apparent from the foregoing that an invention having significant advantages has been provided. While the invention is shown in only a few of its forms, it is not just limited to those forms but is susceptible to various changes and modifications without departing from the spirit thereof.

What is claimed is:

1. A data device comprising:
at least one communication mechanism adapted to receive data and to transmit data;
at least one memory adapted to store at least part of the received data; and
wherein the data device is configured to perform no more computing than organization of the stored data.

2. The device of claim 1, wherein the data device is configured to allow a user to access the stored data.

3. The device of claim 2, wherein the data device is configured to allow a user to visually access the stored data.

4. The device of claim 1, wherein the communication mechanism is adapted to wirelessly receive data and to wirelessly transmit data.

5. The device of claim 4, wherein the wireless communications comprise infrared transmissions.

6. The device of claim 1, wherein the data device is configured to perform no organization of the stored data.

7. A data system comprising:
at least one data device of claim 1;
at least one transmitting computing device;
at least one receiving computing device, that can possibly be the sending computing device;
wherein the transmitting computing device is configured to transmit data that the data device can receive;
wherein the receiving computing device is configured to receive data transmitted by the data device;

8. A data method comprising:
receiving data by a data device;
storing at least part of the data by the data device;
transmitting at least part of the data by the data device; and
computing by the data device no more than to organize the stored data.

9. The method of claim 8, further comprising providing a user with access to at least part of the stored data.

10. The method of claim 9, wherein providing a user with access to at least part of the stored data comprises providing a user with visual access to at least part of the stored data.

11. The method of claim 8,
wherein the receiving data by a data device comprises wirelessly receiving data by a data device; and
wherein the transmitting at least part of the data by a data device comprises wirelessly transmitting at least part of the data by a data device.

12. The method of claim 11, wherein the wireless transmissions comprise infrared transmissions.

13. The method of claim 8, wherein the computing by a data device no more than to organize the stored data is limited such that organizing the stored data is not performed.

14. The method of claim 8, further comprising:
transmitting by a transmitting computing device of the data received by the data device; and
receiving by a receiving computing device of the data transmitted by the data device.

15. A transaction method comprising:
storing payment information in a data device;
transmitting by the data device of the payment information to a transaction computing device; and
receiving by the data device of receipt data from a receipt-providing computing device.

16. The method of claim 15, wherein the payment information comprises credit card data.

17. The method of claim 15, wherein the payment information comprises stored cash value.

18. The method of claim 15, wherein the payment information comprises coupon data.

19. The method of claim 15, further comprising transmitting by the data device of the receipt data to a receipt-receiving computing device.

20. The method of claim 15, further comprising transmitting by the data device of customer data to a customer-data computing device.

21. The method of claim 15, wherein the transmitting comprises wireless transmitting and the receiving comprises wirelessly receiving.

22. The method of claim 15, wherein the transmitting comprises hardwire transmitting and the receiving comprises hardwire receiving.

23. A data device, comprising:
at least one communication mechanism adapted to receive data and to transmit data, wherein the data includes a first biometric information and a payment information;
at least one memory adapted to store at least part of the received data;
at least one biometric information sensor, adapted to input a second biometric information;
a computing module adapted to authenticate identity by comparing the first biometric information and the second biometric information; and
wherein the data device is configured to perform no more computing than organization of the stored data and authentication of the biometric authentication.

24. The method of claim 23, wherein the payment information comprises credit card data.

25. The method of claim 23, wherein the payment information comprises stored cash value.

26. The method of claim 23, wherein the payment information comprises coupon data.

27. The method of claim 23, wherein the biometric information comprises fingerprint information.

28. The method of claim 23, wherein the biometric information comprises voice recognition information.

29. The method of claim 23, wherein the communication mechanism is adapted to wireless communication.
